(19) United States
(12) Patent Application Publication
(10) Pub. No.: US 2025/0290571 A1
(43) Pub. Date: Sep. 18, 2025

(54) Duckbill Flow Control Devices Having a Dynamic Recovery Mechanism and Methods of Using the Same

(71) Applicant: Red Valve Company, Inc., Pittsburgh, PA (US)

(72) Inventor: Jeffrey T. Kelly, Pittsburgh, PA (US)

(21) Appl. No.: 19/077,777

(22) Filed: Mar. 12, 2025

Related U.S. Application Data
(60) Provisional application No. 63/565,266, filed on Mar. 14, 2024.

(51) Int. Cl. F16K 15/14

(52) U.S. Cl. CPC F16K 15/1441; F16K 15/147

(57) ABSTRACT

A duckbill flow control device includes: an upstream inlet end; a downstream outlet end; and a transition portion extending between the inlet end and the outlet end. The outlet end is tapered and includes a top flat area and a bottom flat area that meet in the closed state with a slit formed between the top and bottom flat areas. Further, a dynamic recover mechanism is affixed to the top and bottom flat areas of the outlet end, and the dynamic recover mechanism provides a fast and linear closure of the outlet end during operation as compared to a duckbill flow control device that does not have a dynamic recover mechanism. A method of using the duckbill flow control device is also included.

### CROSS-REFERENCE TO RELATED APPLICATIONS

This application claims priority to U.S. Provisional Patent Application No. 63/565,266 filed Mar. 14, 2024, the disclosure of which is hereby incorporated by reference in its entirety.

### BACKGROUND OF THE INVENTION

### Field of the Invention

This invention generally relates to duckbill diffusers, nozzles, and valves, and more particularly to duckbill diffusers, nozzles, and valves utilized in water treatment, wastewater treatment, industrial processes, and marine applications. Description of Related Art

In various treatment processes, duckbill diffusers, nozzles, and valves are used to control the flow of fluids and gases. For instance, a duckbill diffuser/nozzle/valve can discharge fluids and gases in submerged applications when the internal pressure of the fluid/gas exceeds the external hydrostatic (or atmospheric) pressure against the duckbill body. The elastomeric form of the body allows for closure of the discharge end by applied hydrostatic pressure on the external area of the duckbill body and reduction of internal pressure (no flow).

While duckbill diffusers, nozzles, and valves help control the flow of fluids and gases, there are various drawback associated with such devices. For example, the closure rate of duckbill diffusers/nozzles/valves without supplementary devices can be slow to the point where some fluid or debris is allowed to backflow into the duckbill. Further, the elastomeric tapered end can develop a non-linear form causing separation between the top and bottom portion of the duckbill opening.

Thus, it is desirable to provide duckbill diffusers, nozzles, and valves with a fast and complete closure at the point when a fluid or gas flowing through the duckbill has been shutoff and which are able to maintain a linear form at the elastomeric tapered end.

### SUMMARY OF THE INVENTION

In certain non-limiting embodiments, the present disclosure includes a duckbill flow control device. The device includes: an upstream inlet end; a downstream outlet end; and a transition portion extending between the inlet end and the outlet end. The outlet end is tapered and includes a top flat area and a bottom flat area that meet in the closed state with a slit formed between the top and bottom flat areas. Further, a dynamic recover mechanism is affixed to the top and bottom flat areas of the outlet end, and the dynamic recover mechanism provides a fast and linear closure of the outlet end during operation as compared to a same duckbill flow control device that does not have a dynamic recover mechanism.

In certain non-limiting embodiments, the dynamic recovery mechanism includes pre-stressed and non-malleable individual mechanical components that are affixed to the top and bottom flat areas of the outlet end. The individual mechanical components of the dynamic recovery mechanism can include rods, plates, or a combination thereof that are pre-stressed and non-malleable.

In certain non-limiting embodiments, the individual mechanical components of the dynamic recovery mechanism are positioned in a pre-stressed body form over the top flat area and the bottom flat area, and the individual mechanical components of the dynamic recovery mechanism are affixed in the pre-stressed body form to each side of the top flat area and the bottom flat area of the outlet end. The individual mechanical components of the dynamic recovery mechanism can be embedded into body sidewalls of the each side of the top and bottom flat areas of the outlet end. The individual mechanical components of the dynamic recovery mechanism can also be connected to an external face of each side of the top and bottom flat areas of the outlet end.

In certain non-limiting embodiments, the top and bottom flat areas at the outlet end open in a shape of mirrored parabolas to allow the fluid or gas to flow through a formed discharge port, and the individual mechanical components of the dynamic recovery mechanism bend and flex to produce a potential energy equal to an internal pressure inside the duckbill flow control device. The individual mechanical components of the dynamic recovery mechanism can flex in a direction of the parabolic form of the opened top and bottom flat areas at the outlet end. The flexure direction of the individual mechanical components of the dynamic recovery mechanism can be opposite of the pre-stressed direction for the individual mechanical components of the dynamic recovery mechanism providing potential energy at the outlet end.

In certain non-limiting embodiments, the individual mechanical components of the dynamic recovery mechanism provide the fast and linear closure of the outlet end as compared to the duckbill flow control device that does not have a dynamic recover mechanism, when the internal pressure is discontinued or lowered and kinetic energy in the dynamic recovery mechanism is released. The dynamic recovery mechanism can also provide a positive seal across the slit when the duckbill flow control device is in the closed state to prevent fluids and solids from back-flowing into the duckbill flow control device.

In certain non-limiting embodiments, the duckbill flow control device is a duckbill diffuser, a duckbill nozzle, or a duckbill valve.

In certain non-limiting embodiments, the present disclosure also includes a method for controlling the flow of fluid or gas through a duckbill flow control device. The method includes: introducing a fluid or gas through the inlet end of the duckbill flow control device according to any one of the duckbill flow control devices described herein; allowing unrestricted flow of the fluid or gas through an opened discharge port at the outlet end when internal pressure inside the duckbill flow control device is greater than external pressure exerted onto an outside of the duckbill flow control device; discontinuing the flow or lowering a flow rate of the fluid or gas into the duckbill flow control device; and closing the opened discharge port when the external pressure exceeds the internal pressure. The discharge port closes at a rate faster with the dynamic recovery mechanism than a same duckbill flow control device that does not have the dynamic recovery mechanism.

In certain non-limiting embodiments, the dynamic recovery mechanism provides a positive seal across the slit when the duckbill flow control device is in the closed state to prevent fluids and solids from back-flowing into the duckbill flow control device. The dynamic recovery mechanism can also maintain a linear shape of the closure between the top flat area and the bottom flat area of the outlet end.

In certain non-limiting embodiments, during the unrestricted flow of the fluid or gas through an opened discharge port, the top and bottom flat areas at the outlet end are open in a shape of mirrored parabolas, and the individual mechanical components of the dynamic recovery mechanism bend and flex to produce a potential energy equal to an internal pressure inside the duckbill flow control device. As previously described, the individual mechanical components of the dynamic recovery mechanism can flex in a direction of the parabolic form of the opened top and bottom flat areas at the outlet end, and the flexure direction of the individual mechanical components of the dynamic recovery mechanism is opposite of the pre-stressed direction for the individual mechanical components of the dynamic recovery mechanism providing potential energy at the outlet end.

The present disclosure also relates to the following aspects.

Aspect 1: A duckbill flow control device comprising: an upstream inlet end; a downstream outlet end; and a transition portion extending between the inlet end and the outlet end, wherein the outlet end is tapered and comprises a top flat area and a bottom flat area that meet in the closed state with a slit formed between the top and bottom flat areas, and wherein a dynamic recover mechanism is affixed to the top and bottom flat areas of the outlet end, and wherein the dynamic recover mechanism provides a fast and linear closure of the outlet end during operation as compared to a duckbill flow control device that does not have a dynamic recover mechanism.

Aspect 2: The device of aspect 1, wherein the dynamic recovery mechanism comprises pre-stressed and non-malleable individual mechanical components that are affixed to the top and bottom flat areas of the outlet end.

Aspect 3: The device of aspect 2, wherein the individual mechanical components of the dynamic recovery mechanism comprise rods, plates, or a combination thereof that are pre-stressed and non-malleable.

Aspect 4: The device of aspects 2 or 3, wherein the individual mechanical components of the dynamic recovery mechanism are positioned in a pre-stressed body form over the top flat area and the bottom flat area, and wherein the individual mechanical components of the dynamic recovery mechanism are affixed in the pre-stressed body form to each side of the top flat area and the bottom flat area of the outlet end.

Aspect 5: The device of any one of aspects 2-4, wherein the individual mechanical components of the dynamic recovery mechanism are embedded into body sidewalls of the each side of the top and bottom flat areas of the outlet end.

Aspect 6: The device of any one of aspects 2-5, wherein the individual mechanical components of the dynamic recovery mechanism are connected to an external face of each side of the top and bottom flat areas of the outlet end.

Aspect 7: The device of any one of aspects 2-6, wherein the top and bottom flat areas at the outlet end open in a shape of mirrored parabolas to allow the fluid or gas to flow through a formed discharge port, and the individual mechanical components of the dynamic recovery mechanism bend and flex to produce a potential energy equal to an internal pressure inside the duckbill flow control device.

Aspect 8: The device of aspect 7, wherein the individual mechanical components of the dynamic recovery mechanism flex in a direction of the parabolic form of the opened top and bottom flat areas at the outlet end.

Aspect 9: The device of aspect 8, wherein the flexure direction of the individual mechanical components of the dynamic recovery mechanism is opposite of the pre-stressed direction for the individual mechanical components of the dynamic recovery mechanism providing potential energy at the outlet end.

Aspect 10: The device of any one of aspects 2-9, wherein the individual mechanical components of the dynamic recovery mechanism provides the fast and linear closure of the outlet end as compared to the duckbill flow control device that does not have a dynamic recover mechanism, when the internal pressure is discontinued or lowered and kinetic energy in the dynamic recovery mechanism is released.

Aspect 11: The device of any one of aspects 1-10, wherein the dynamic recovery mechanism provides a positive seal across the slit when the duckbill flow control device is in the closed state to prevent fluids and solids from back-flowing into the duckbill flow control device.

Aspect 12: The device of any one of aspects 1-11, wherein the duckbill flow control device is a duckbill diffuser, a duckbill nozzle, or a duckbill valve.

Aspect 13: A method for controlling the flow of fluid or gas through a duckbill flow control device, the method comprising: introducing a fluid or gas through the inlet end of the duckbill flow control device according to any one of aspects 1-12; allowing unrestricted flow of the fluid or gas through an opened discharge port at the outlet end when internal pressure inside the duckbill flow control device is greater than external pressure exerted onto an outside of the duckbill flow control device; discontinuing the flow or lowering a flow rate of the fluid or gas into the duckbill flow control device; and closing the opened discharge port when the external pressure exceeds the internal pressure, wherein the discharge port closes at a rate faster with the dynamic recovery mechanism than a same duckbill flow control device that does not have the dynamic recovery mechanism.

Aspect 14: The method of aspect 13, wherein the dynamic recovery mechanism provides a positive seal across the slit when the duckbill flow control device is in the closed state to prevent fluids and solids from back-flowing into the duckbill flow control device.

Aspect 15: The method of aspects 13 or 14, wherein the dynamic recovery mechanism maintains a linear shape of the closure between the top flat area and the bottom flat area of the outlet end.

Aspect 16: The method of any one of aspects 13-15, wherein the dynamic recovery mechanism comprises pre-stressed and non-malleable individual mechanical components that are affixed to the top and bottom flat areas of the outlet end.

Aspect 17: The method of aspect 16, wherein, during the unrestricted flow of the fluid or gas through an opened discharge port, the top and bottom flat areas at the outlet end are open in a shape of mirrored parabolas, and the individual mechanical components of the dynamic recovery mechanism bend and flex to produce a potential energy equal to an internal pressure inside the duckbill flow control device.

Aspect 18: The method of aspect 17, wherein the individual mechanical components of the dynamic recovery mechanism flex in a direction of the parabolic form of the opened top and bottom flat areas at the outlet end, and the flexure direction of the individual mechanical components of the dynamic recovery mechanism is opposite of the pre-stressed direction for the individual mechanical components of dynamic recovery mechanism providing potential energy at the outlet end.

Aspect 19: The method of any one of aspects 16-18, wherein the individual mechanical components of the dynamic recovery mechanism comprise rods, plates, or a combination thereof that are pre-stressed and non-malleable.

Aspect 20: The method of any one of aspects 16-19, wherein the individual mechanical components of the dynamic recovery mechanism are positioned in a pre-stressed body form over the top flat area and the bottom flat area, and wherein the individual mechanical components of the dynamic recovery mechanism are affixed in the pre-stressed body form to each side of the top flat area and the bottom flat area of the outlet end.

### BRIEF DESCRIPTION OF THE DRAWINGS

FIG. 1 is a top view of a duckbill flow control device according to a non-limiting embodiment of the present disclosure;

FIG. 2 is a side view of a duckbill flow control device in the closed state according to a non-limiting embodiment of the present disclosure;

FIG. 3 is a front view of FIG. 2;

FIG. 4 is a side view of a duckbill flow control device in the open state according to a non-limiting embodiment of the present disclosure; and

FIG. 5 is a front view of FIG. 4.

### DESCRIPTION OF THE INVENTION

For the purpose of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plurals encompasses the singular, unless specifically stated otherwise. In addition, in this application, the use of “or” means “and/or” unless specifically stated otherwise, even though “and/or” may be explicitly used in certain instances.

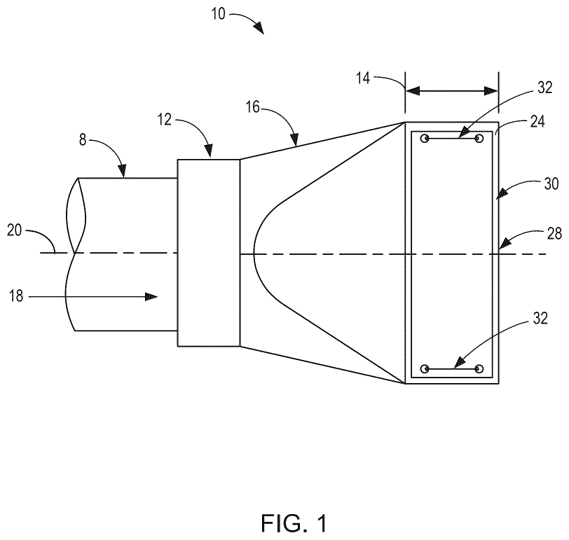

Referring to FIGS. 1-5, the present disclosure includes a duckbill diffuser, nozzle, or valve 10 (referred to herein as a “duckbill flow control device 10”). As shown in FIG. 1, the duckbill flow control device 10 includes an upstream inlet end 12 that is mountable on a discharge conduit 8, a downstream outlet end 14, and a transition portion 16 that extends between the inlet end 12 and the outlet end 14. Primary flow 18 through the duckbill flow control device 10 is parallel to the longitudinal centerline 20 of the duckbill flow control device 10. The headloss (pressure drop) as the fluid or gas flows through the duckbill flow control device 10 has a linear relationship with the flow rate of the fluid or gas passing through the duckbill flow control device 10.

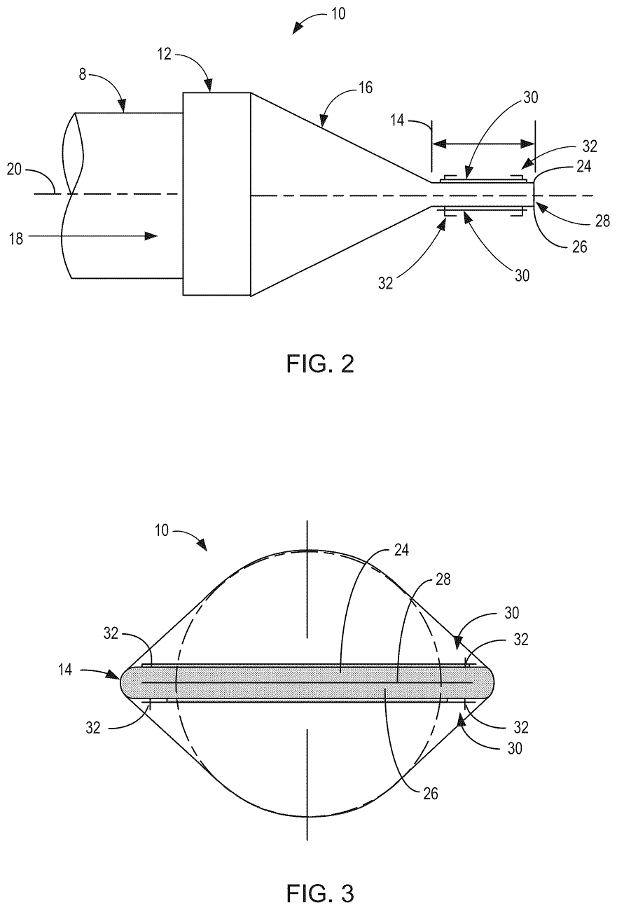

As shown in FIG. 2, the transition portion 16 can extend at an angle from the inlet end 12 to the outlet end 14. Referring to FIGS. 2 and 3, the outlet end 14 tapers somewhat like the bill of a duck and includes a top flat area 24 and bottom flat area 26 that meet in the closed state to prevent fluid or gas from flowing through the outlet end 14. As shown in FIGS. 3 and 5, a slit 28 is formed between the flat areas 24 and 26 that opens to form a discharge port 22 when internal pressure 40 from flowing fluid or gas reaches a certain level. It is appreciated that the flat areas 24 and 26 can open in the shape of two mirrored parabolas, as shown in FIG. 5. The inlet end 12, a downstream outlet end 14, and a transition portion 16 can be formed from various material including various types of elastomeric materials.

In certain non-limiting embodiments, referring to FIGS. 1-5, a dynamic recovery mechanism 30 is affixed to the outlet end 14 of the duckbill flow control device 10. The dynamic recovery mechanism 30 can include pre-stressed and non-malleable individual mechanical components. Non-limiting examples of such individual mechanical components include rods, plates, or a combination thereof that are pre-stressed and non-malleable. The individual mechanical components of the dynamic recovery mechanism 30 can be formed from various materials including various types of metals that are non-malleable and pre-stressed.

As used herein, “pre-stressed” refers to mechanical components (e.g., rods and plates) stressed to a certain level prior to being affixed to the outlet end 14 of the duckbill flow control device 10 in order to improve structure properties, such as the strength of the mechanical components. Further, the term “non-malleable”, as used herein, refers to mechanical components (e.g., rods and plates) that do not result in permanent bending or being changed into a new shape when flexed to allow the flow of fluid or gas through the discharge port 22.

The dynamic recovery mechanism 30 can be attached to the external surfaces of the outlet end 14 and/or to the internal surfaces of the outlet end 14. The dynamic recovery mechanism 30 can also be attached to various areas of the outlet end 14. For example, as shown in FIGS. 1-5, the individual mechanical components of the dynamic recovery mechanism 30 can be affixed in a pre-stressed body form to each side of the flat areas 24 and 26 of the outlet end 14.

The dynamic recovery mechanism 30 can be attached to the outlet end 14 using various methods including embedding the individual mechanical components of the dynamic recovery mechanism 30 into the body sidewalls of the sides of flat areas 24 and 26, or connecting the individual mechanical components of the dynamic recovery mechanism 30 to the external face of the sides of flat areas 24 and 26. As shown in FIGS. 1-5, the individual mechanical components of the dynamic recovery mechanism 30 are attached to each side of the flat areas 24 and 26 with an anchoring mechanism 32. The anchoring mechanism 32 can include a fastener or other type of component that affixes the individual mechanical components of the dynamic recovery mechanism 30 to the sides of the flat areas 24 and 26.

It is appreciated that the individual mechanical components of the dynamic recovery mechanism 30 can extend across the entire flat areas 24 and 26 (e.g., from one side to an opposite side of each flat area 24 and 26), or the individual mechanical components of the dynamic recovery mechanism 30 can extend across only a portion of flat areas 24 and 26. For instance, in certain non-limiting embodiments referring to FIGS. 1-5, the dynamic recovery mechanism 30 comprises: (i) a first individual component (i.e., a non-malleable and pre-stressed plate) that extends from one side to the opposite side of the top flat area 24 and which is affixed at each side with an anchoring mechanism 32; and (ii) a second individual component (i.e., a non-malleable and pre-stressed plate) that extends from one side to the opposite side of the bottom flat area 26 and which is affixed at each side with an anchoring mechanism 32.

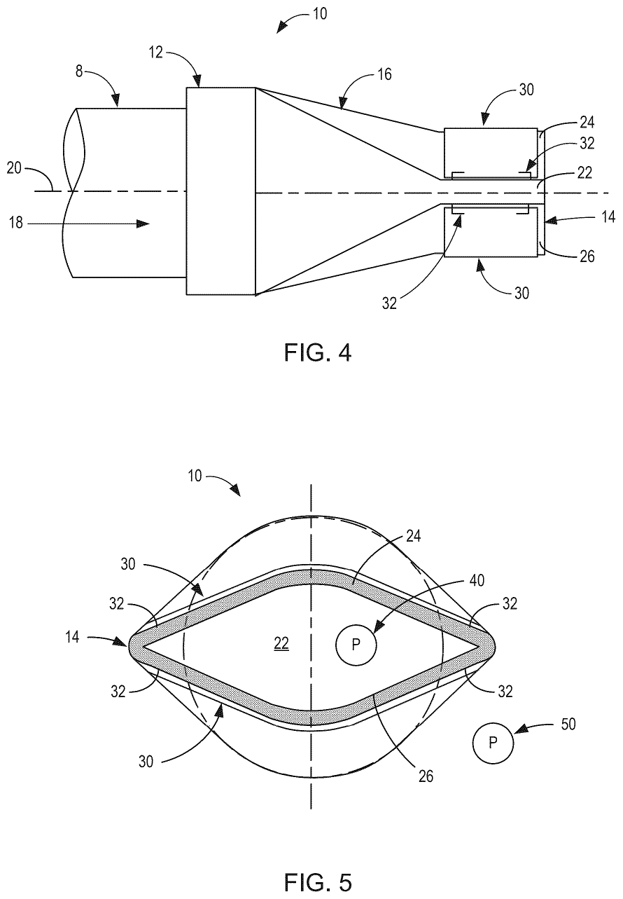

During operation, fluid or gas flows into the upstream inlet end 12, through the transition portion 16, and toward the outlet end 14. When internal pressure 40 is applied to the inside of the duckbill flow control device 10 (via hydraulic fluid or gas) and is greater than the external pressure 50 applied to the outside of the duckbill flow control device 10, the slit 28 at the outlet end 14 will begin to open as the body of the duckbill flow control device 10 expands. Referring to FIGS. 4 and 5, as the internal pressure 40 increases, the flat areas 24 and 26 at the outlet end 14 open in the shape of mirrored parabolas allowing the fluid or gas to flow through the formed discharge port 22.

The internal pressure 40 also forces the mechanical components of the dynamic recovery mechanism 30 to bend and flex producing a potential energy in the mechanism 30 equal to the internal pressure 40 applied. Referring again to FIGS. 4 and 5, it is appreciated that the dynamic recovery mechanism 30 is also flexed in the direction of the opened flat areas 24 and 26 having the parabolic form. This flexure direction is opposite the pre-stressed direction for the dynamic recovery mechanism 30 providing potential energy at the discharge port 22. As shown in FIGS. 2 and 3, when the internal pressure 40 is discontinued, the kinetic energy in the mechanism 30 is released resulting in fast closure of the discharge port 22.

The present disclosure also includes a method of controlling the flow of fluid or gas through any of the previously described duckbill flow control devices 10. The method includes: introducing a fluid or gas through the inlet end 12 of one of the previously described duckbill flow control devices 10; allowing unrestricted flow of the fluid or gas through the discharge port 22 of the duckbill flow control device 10 when internal pressure 40 inside the duckbill flow control device 10 is greater than external pressure 50 exerted onto an outside of the duckbill flow control device 10; discontinuing the flow or lowering a flow rate of the fluid or gas into the duckbill flow control device 10; and closing the opened discharge port 22 when the external pressure 50 exceeds the internal pressure 40. The discharge port 22 closes at a rate faster with the dynamic recovery mechanism 30 than a same duckbill flow control device 10 that does not have the dynamic recovery mechanism 30.

In certain non-limiting embodiments, the method also prevents fluids and solids from back-flowing into the duckbill flow control device 10 by applying a strong, positive seal across the slit 28 with the help of the dynamic recovery mechanism 30. In addition to the fast closure rate and preventing fluids and solids from back-flowing, the dynamic recovery mechanism 30 further helps maintain the linear shape/form of the closure between the top flat area 24 and the bottom flat area 26 of the outlet end 14.

It is appreciated that the method uses the previously described individual mechanical components of the dynamic recovery mechanism 30 (e.g., the pre-stressed, non-malleable plates and/or rods) to flex open in the direction of the opened flat areas 24 and 26 having the parabolic form, and then to close the discharge port 22 with a fast and linear closure process when the kinetic energy in the mechanism 30 is released.

It was found that the duckbill flow control device 10 and methods of using the device 10 of the present disclosure overcome the known drawbacks in previously known duckbill flow control device 10. For instance, as previously described, the duckbill flow control device 10 and methods of using the device 10 of the present disclosure utilize the dynamic recovery mechanism 30 to provide a fast and linear closure of the duckbill flow control device 10 that prevents fluids and solids from back-flowing.

Whereas particular embodiments of this invention have been described above for purposes of illustration, it will be evident to those skilled in the art that numerous variations of the details of the present invention may be made without departing from the invention.

The invention claimed is:

1. A duckbill flow control device comprising:
an upstream inlet end;
a downstream outlet end; and
a transition portion extending between the inlet end and the outlet end,
wherein the outlet end is tapered and comprises a top flat area and a bottom flat area that meet in a closed state with a slit formed between the top and bottom flat areas, and
wherein a dynamic recover mechanism is affixed to the top and bottom flat areas of the outlet end, and wherein the dynamic recover mechanism provides a fast and linear closure of the outlet end during operation as compared to a duckbill flow control device that does not have a dynamic recover mechanism.

2. The device of claim 1, wherein the dynamic recovery mechanism comprises pre-stressed and non-malleable individual mechanical components that are affixed to the top and bottom flat areas of the outlet end.

3. The device of claim 2, wherein the individual mechanical components of the dynamic recovery mechanism comprise rods, plates, or a combination thereof that are pre-stressed and non-malleable.

4. The device of claim 2, wherein the individual mechanical components of the dynamic recovery mechanism are positioned in a pre-stressed body form over the top flat area and the bottom flat area, and wherein the individual mechanical components of the dynamic recovery mechanism are affixed in the pre-stressed body form to each side of the top flat area and the bottom flat area of the outlet end.

5. The device of claim 4, wherein the individual mechanical components of the dynamic recovery mechanism are embedded into body sidewalls of the each side of the top and bottom flat areas of the outlet end.

6. The device of claim 4, wherein the individual mechanical components of the dynamic recovery mechanism are connected to an external face of each side of the top and bottom flat areas of the outlet end.

7. The device of claim 2, wherein the top and bottom flat areas at the outlet end open in a shape of mirrored parabolas to allow the fluid or gas to flow through a formed discharge port, and the individual mechanical components of the dynamic recovery mechanism bend and flex to produce a potential energy equal to an internal pressure inside the duckbill flow control device.

8. The device of claim 7, wherein the individual mechanical components of the dynamic recovery mechanism flex in a direction of the parabolic form of the opened top and bottom flat areas at the outlet end.

9. The device of claim 8, wherein a flexure direction of the individual mechanical components of the dynamic recovery mechanism is opposite of the pre-stressed direction for the individual mechanical components of the dynamic recovery mechanism providing potential energy at the outlet end.

10. The device of claim 7, wherein the individual mechanical components of the dynamic recovery mechanism provide the fast and linear closure of the outlet end as compared to the duckbill flow control device that does not have a dynamic recover mechanism, when the internal pressure is discontinued or lowered and kinetic energy in the dynamic recovery mechanism is released.

11. The device of claim 1, wherein the dynamic recovery mechanism provides a positive seal across the slit when the duckbill flow control device is in the closed state to prevent fluids and solids from back-flowing into the duckbill flow control device.

12. The device of claim 1, wherein the duckbill flow control device is a duckbill diffuser, a duckbill nozzle, or a duckbill valve.

13. A method for controlling the flow of fluid or gas through a duckbill flow control device, the method comprising:
introducing a fluid or gas through the inlet end of a duckbill flow control device comprising an upstream inlet end, a downstream outlet end, and a transition portion extending between the inlet end and the outlet end, wherein the outlet end is tapered and comprises a top flat area and a bottom flat area that meet in a closed state with a slit formed between the top and bottom flat areas;
allowing unrestricted flow of the fluid or gas through an opened discharge port at the outlet end when internal pressure inside the duckbill flow control device is greater than external pressure exerted onto an outside of the duckbill flow control device;
discontinuing the flow or lowering a flow rate of the fluid or gas into the duckbill flow control device; and
closing the opened discharge port when the external pressure exceeds the internal pressure,
wherein a dynamic recover mechanism is affixed to the top and bottom flat areas of the outlet end, and wherein the discharge port closes at a rate faster with the dynamic recovery mechanism than a duckbill flow control device that does not have the dynamic recovery mechanism.

14. The method of claim 13, wherein the dynamic recovery mechanism provides a positive seal across the slit when the duckbill flow control device is in the closed state to prevent fluids and solids from back-flowing into the duckbill flow control device.

15. The method of claim 13, wherein the dynamic recovery mechanism maintains a linear shape of the closure between the top flat area and the bottom flat area of the outlet end.

16. The method of claim 13, wherein the dynamic recovery mechanism comprises pre-stressed and non-malleable individual mechanical components that are affixed to the top and bottom flat areas of the outlet end.

17. The method of claim 16, wherein, during the unrestricted flow of the fluid or gas through the opened discharge port, the top and bottom flat areas at the outlet end are open in a shape of mirrored parabolas, and the individual mechanical components of the dynamic recovery mechanism bend and flex to produce a potential energy equal to an internal pressure inside the duckbill flow control device.

18. The method of claim 17, wherein the individual mechanical components of the dynamic recovery mechanism flex in a direction of the parabolic form of the opened top and bottom flat areas at the outlet end, and a flexure direction of the individual mechanical components of the dynamic recovery mechanism is opposite of the pre-stressed direction for the individual mechanical components of the dynamic recovery mechanism providing potential energy at the outlet end.

19. The method of claim 16, wherein the individual mechanical components of the dynamic recovery mechanism comprise rods, plates, or a combination thereof that are pre-stressed and non-malleable.

20. The method of claim 16, wherein the individual mechanical components of the dynamic recovery mechanism are positioned in a pre-stressed body form over the top flat area and the bottom flat area, and wherein the individual mechanical components of the dynamic recovery mechanism are affixed in the pre-stressed body form to each side of the top flat area and the bottom flat area of the outlet end.
